(19) United States
(12) Patent Application Publication
(10) Pub. No.: US 2019/0033926 A1
(43) Pub. Date: Jan. 31, 2019

(54) MOBILE TERMINAL

(71) Applicant: WUHAN CHINA STAR OPTOELECTRONICS SEMICONDUCTOR DISPLAY TECHNOLOGY CO., LTD., Wuhan, Hubei (CN)

(72) Inventors: Jinchang HUANG, Wuhan (CN); Hsiang-Iun HSU, Wuhan (CN)

(21) Appl. No.: 15/572,499

(22) PCT Filed: Sep. 6, 2017
(86) PCT No.: PCT/CN2017/100695

§ 371 Date: Nov. 8, 2017

(30) Foreign Application Priority Data
Jul. 26, 2017 (CN) 201710615441.6

(51) Int. Cl. G06F 1/16; H04M 1/725

(52) U.S. Cl. CPC G06F 1/1686; H04M 2250/52; H04M 1/72519; G06F 1/1626

(57) ABSTRACT

In a mobile terminal of the present disclosure, the mobile terminal includes a terminal body, a display panel, a movable member, and a camera. The movable member is connected with the terminal body. The camera is arranged on the movable member. The movable member is configured for driving the camera such that the camera is hidden in the terminal body or exposed outside the terminal body. In the present disclosure, a preset region does not need to be reserved for the camera in a surface corresponding to the display panel.

### BACKGROUND

### Field

The present disclosure relates to a technical field of consumer electronics, and more particularly to a mobile terminal.

### Background

A traditional mobile terminal generally includes a front-mounted camera and a rear-mounted camera. The front camera is generally arranged above a display screen of the mobile terminal. The front-mounted camera cannot be hidden or reduce area in the mobile terminal. Thus, a surface that corresponds to the display screen in the mobile terminal needs to reserve a preset region for the front-mounted camera. However, due to the preset region, the mobile terminal cannot have frameless or narrow frames.

Therefore, there is a need to provide a new technical scheme so as to solve above-mentioned problems.

### SUMMARY OF THE DISCLOSURE

Embodiments of the present disclosure provide a mobile terminal, and a preset region does not need to be reserved for a camera in a surface corresponding to the display area, such that a frameless or narrow frame can be conveniently achieved.

An embodiment of the present disclosure provides a mobile terminal. The mobile terminal includes a terminal body. The terminal body includes a display region and a non-display region. The display region is arranged on a first surface of the terminal body. The non-display region is arranged on a second surface of the terminal body. The first surface and the second surface are two adjacent surfaces of the terminal body in a three-dimensional space. A display panel is arranged on the display region of the terminal body. An image device is arranged on the non-display region of the terminal body. The image device includes a movable member and a camera. The movable member is connected with the terminal body. The camera is arranged on the movable member. The movable member is configured for driving the camera such that the camera is hidden in the terminal body or exposed outside the terminal body. The movable member further includes a bracket and a movable component. The movable component is connected with the bracket and the terminal body. The camera is arranged on the bracket. A preset included angle is defined between the first surface and the second surface. The preset included angle ranges from 20 degrees to 160 degrees.

In the mobile terminal, the bracket and the movable component are configured for hiding the camera in the terminal body or exposing the camera outside the terminal body in a translation or rotational manner.

In the mobile terminal, the movable component is a rotation shaft. The bracket includes a rotation hole. The rotation shaft is inserted into the rotation hole in a pivoting manner, and at least a part of the rotation shaft is fixed to the terminal body.

In the mobile terminal, the bracket is configured for rotating around the rotating shaft at a preset angle, such that the camera is hidden in the terminal body or exposed outside the terminal body.

In the mobile terminal, the bracket includes a first end and a second end. The rotating hole is arranged in the first end of the bracket. The camera is arranged at the second end of the bracket.

An embodiment of the present disclosure provides a mobile terminal. The mobile terminal includes a terminal body. The terminal body includes a display region and a non-display region. The display region is arranged on a first surface of the terminal body. The non-display region is arranged on a second surface of the terminal body. The first surface and the second surface are two adjacent surfaces of the terminal body in a three-dimensional space. A display panel is arranged on the display region of the terminal body. An image device is arranged on the non-display region of the terminal body. The image device includes a movable member and a camera. The movable member is connected with the terminal body. The camera is arranged on the movable member. The movable member is configured for driving the camera such that the camera is hidden in the terminal body or exposed outside the terminal body.

In the mobile terminal, the bracket and the movable component are configured for hiding the camera in the terminal body or exposing the camera outside the terminal body in a translation or rotational manner.

In the mobile terminal, the movable component is a rotation shaft. The bracket includes a rotation hole. The rotation shaft is inserted into the rotation shaft in a pivoting manner, and at least a part of the rotation shaft is fixed to the terminal body.

In the mobile terminal, the bracket is configured for rotating around the rotating shaft at a preset angle, such that the camera is hidden in the terminal body or exposed outside the terminal body.

In the mobile terminal, the bracket includes a first end and a second end. The rotating hole is arranged in the first end of the bracket. The camera is arranged at the second end of the bracket.

In the mobile terminal, the movable component includes an assembly of a sliding block and a sliding groove. One of the sliding block and the sliding groove is arranged in the terminal body, and the other of the sliding block and the sliding groove is arranged on an outer surface of the bracket.

In the mobile terminal, the bracket is configured for sliding along a track that is defined by the sliding block and the sliding groove, such that the camera is hidden in the terminal body or exposed outside the terminal body.

In the mobile terminal, the sliding groove includes a wave shape, a spring is arranged in the sliding block, and the spring is connected with the terminal body or the bracket. The spring is configured to pop up or recover the sliding block, such that the sliding block is coupled with a wave peak and a wave trough in the sliding groove having a wave shape.

In the mobile terminal, the first surface and the second surface includes a preset included angle. The preset included angle ranges from 20 degrees to 160 degrees.

In the mobile terminal, the preset included angle ranges from 70 degrees to 110 degrees.

In the mobile terminal, at least one of the first surface and the second surface is a planar or curved surface, and wherein when at least one of the first surface and the second surface is the curved surface, a plane corresponding to the first surface is defined as a tangent plane of the first surface in a central position of the first surface, and a plane corresponding to the second surface is defined as a tangent plane of the second surface in a central position of the second surface.

In the mobile terminal, the mobile terminal further includes a control device arranged in the terminal body. The control device is configured to control movable member, such that the camera is hidden in the terminal body or exposed outside the terminal body.

In the mobile terminal, the control device includes a motor and a transmission component, the motor is connected to a control circuit of the terminal body, the motor further is connected to the transmission component, the transmission component is connected to the movable member, and wherein the motor is configured for driving the movable member using the transmission component, such that the camera is hidden in the terminal body or exposed outside the terminal body.

In the mobile terminal, the transmission component is a gear set, and the gear set includes at least one gear.

### BRIEF DESCRIPTION OF THE DRAWINGS

FIG. 1 is an illustrative isometric diagram of a mobile terminal according to one embodiment of the present disclosure.

FIG. 2 is an illustrative schematic diagram of a movable member in the mobile terminal shown in FIG. 1 where the movable member is configured to hide a camera in a housing of the mobile terminal using a rotational manner according to one embodiment of the present disclosure.

FIG. 3 is an illustrative schematic diagram of the movable member in the mobile terminal shown in FIG. 1 where the movable member is configured to expose the camera outside the housing of the mobile terminal using the rotational manner according to one embodiment of the present disclosure.

FIG. 4 is an illustrative schematic diagram of a movable member in the mobile terminal shown in FIG. 1 where the movable member is configured to hide a camera in a housing of the mobile terminal using a translation manner according to one embodiment of the present disclosure.

FIG. 5 is an illustrative schematic diagram of the movable member in the mobile terminal shown in FIG. 1 where the movable member is configured to expose the camera outside the housing of the mobile terminal using the translation manner according to one embodiment of the present disclosure.

### DETAILED DESCRIPTION OF THE PREFERRED EMBODIMENTS

The following embodiments refer to the accompanying drawings for exemplifying specific implementable embodiments of the present disclosure in a suitable computing environment. It should be noted that the exemplary described embodiments are configured to describe and understand the present disclosure, but the present disclosure is not limited thereto. In addition, the articles “a” and “an” described in the specification and claims are used, and generally can be interpreted as “one or more”, unless specified otherwise or clear from the context, the singular forms can be clearly determined.

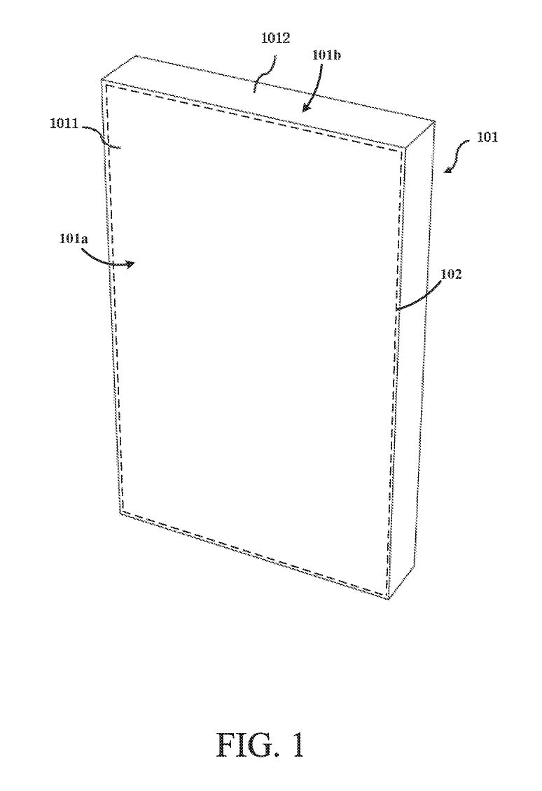

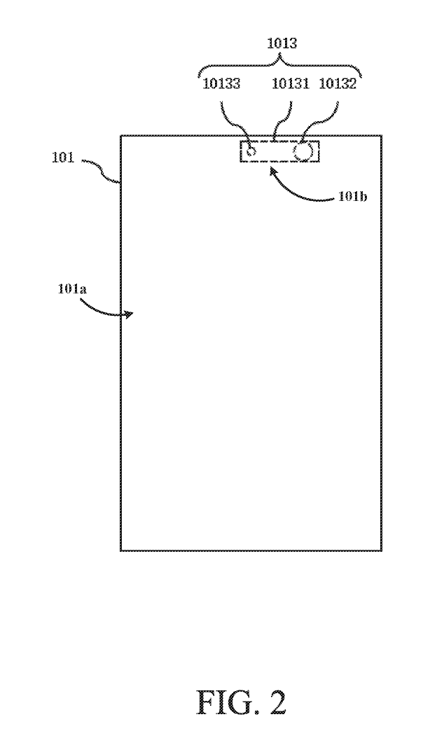

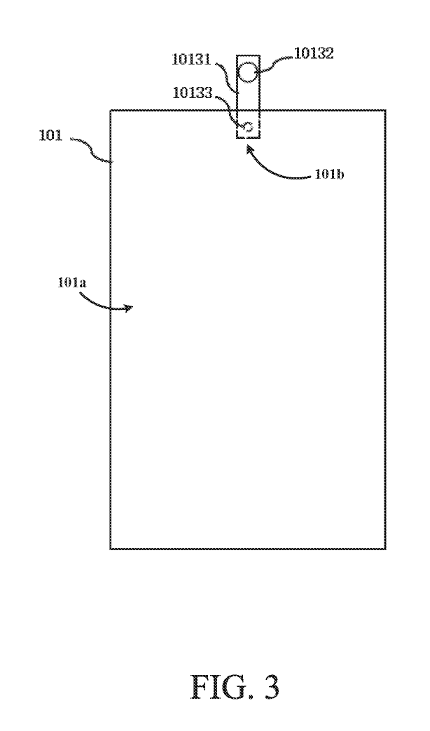

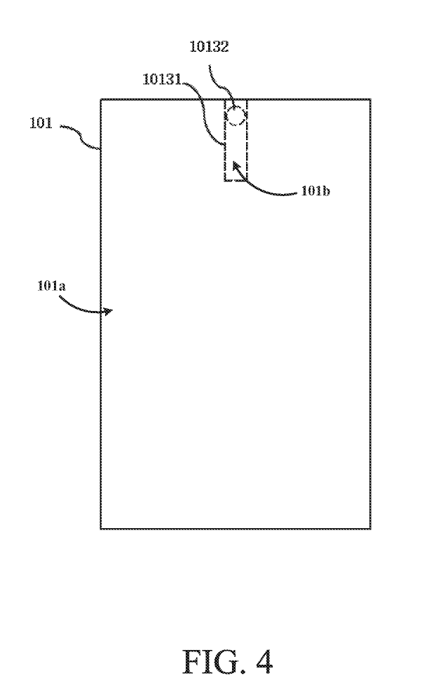

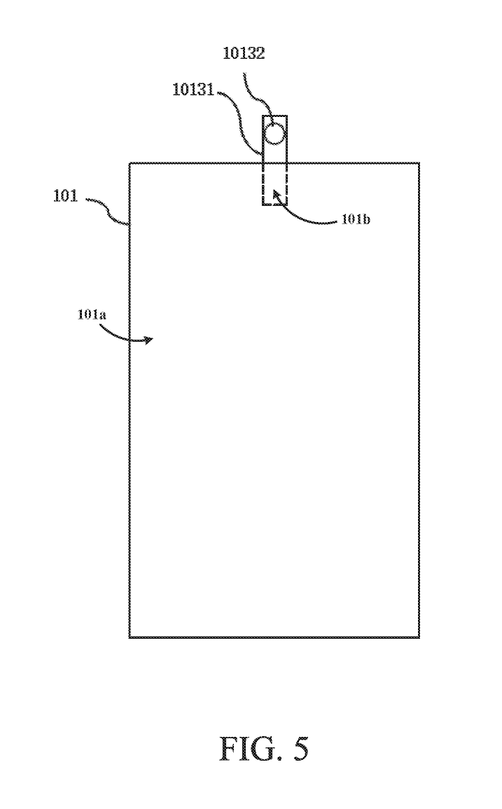

FIG. 2 is an illustrative schematic diagram of a movable member in the mobile terminal shown in FIG. 1, where the movable member is configured to hide a camera 10132 in a housing 101 of the mobile terminal using a rotational manner, according to one embodiment of the present disclosure. FIG. 3 is an illustrative schematic diagram of the movable member in the mobile terminal shown in FIG. 1 where the movable member is configured to expose the camera 10132 outside the housing 101 of the mobile terminal using the rotational manner according to one embodiment of the present disclosure. FIG. 4 is an illustrative schematic diagram of a movable member in the mobile terminal shown in FIG. 1 where the movable member is configured to hide a camera 10132 in a housing 101 of the mobile terminal using a translation manner according to one embodiment of the present disclosure. FIG. 5 is an illustrative schematic diagram of the movable member in the mobile terminal shown in FIG. 1 where the movable member is configured to expose the camera 10132 outside the housing 101 of the mobile terminal using the translation manner according to one embodiment of the present disclosure.

In one embodiment, the mobile terminal includes a terminal body 101, a display panel, and an image device 1013. The display panel can be a thin film transistor liquid crystal display (TFT-LCD), an organic light emitting diode (OLED) display panel, or the like.

The terminal body 101 includes a display region and a non-display region. The display region is arranged on a first surface 1011 of the terminal body 101. The non-display region is arranged on a second surface 1012 of the terminal body 101. The first surface 1011 and the second surface 1012 are two adjacent surfaces of the terminal body 101 in a three-dimensional space. The first surface 1011 and the second surface 1012 are in different dimensions in three-dimensional space.

The display panel is arranged on the display region of the terminal body 101.

The image device 1013 is arranged on the non-display region of the terminal body 101, and the image device 1013 includes a movable member and a camera 10132.

The movable member is connected with the terminal body 101.

The camera 10132 is arranged on the movable member.

The movable member is configured for driving the camera 10132 such that the camera 10132 is hidden in the terminal body 101 or exposed outside the terminal body 101.

The movable member includes a bracket 10131 and a movable component 10133. The movable component 10133 is connected with the bracket 10131 and the terminal body 101. The camera 10132 is arranged on the bracket 10131.

The bracket 10131 and the movable component 10133 are configured for hiding the camera 10132 in the terminal body 101 or exposing the camera 10132 outside the terminal body 101 in a translation or rotational manner.

In one embodiment, the movable component 10133 is a rotation shaft. The bracket 10131 includes a rotation hole. The rotation shaft is inserted into the rotation hole in a pivoting manner, and at least a part of the rotation shaft is fixed to the terminal body 101.

In one embodiment, the bracket 10131 is configured for rotating around the rotating shaft at a preset angle, such that the camera 10132 can be hidden in the terminal body 101 or exposed outside the terminal body 101.

In one embodiment, the bracket 10131 includes a first end and a second end. The rotating hole is arranged in the first end of the bracket 10131, and the camera 10132 is arranged at the second end of the bracket 10131.

In one embodiment, the movable component 10133 includes an assembly of a sliding block and a sliding groove. One of the sliding block and the sliding groove is arranged in the terminal body 101, and the other of the sliding block and the sliding groove is arranged on an outer surface of the bracket 10131.

In one embodiment, the bracket 10131 is configured for sliding along a track defined by the sliding block and the sliding groove, such that the camera 10132 can be hidden in the terminal body 101 or exposed outside the terminal body 101.

In one embodiment, the sliding groove includes a wave shape, and a spring is further arranged in the sliding block. The spring is connected with the terminal body 101 or the bracket 10131. The spring is configured to pop up or recover the sliding block, such that the sliding block is coupled with a wave peak and a wave trough in the sliding groove having the wave shape.

In one embodiment, a preset included angle is defined between the first surface 1011 and the second surface 1012. The preset included angle ranges from 20 degrees to 160 degrees. For example, the preset included angle is selected from a group consisting of 20 degrees, 25 degrees, 30 degrees, 35 degrees, 40 degrees, 45 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees, 125 degrees, 130 degrees, 135 degrees, 140 degrees, 145 degrees, 150 degrees, 155 degrees and 160 degrees.

Preferably, the preset included angle is 90 degrees.

At least one of the first surface 1011 and the second surface 1012 is a planar or curved surface. In one embodiment, when at least one of the first surface 1011 and the second surface 1012 is the curved surface, a plane corresponding to the first surface 1011 is defined as a tangent plane of the first surface 1011 in a central position of the first surface 1011, and a plane corresponding to the second surface 1012 is defined as a tangent plane of the second surface 1012 in a central position of the second surface 1012.

In one embodiment, the mobile terminal further includes a control device that is arranged in the terminal body 1011. The control device is configured to control movable member such that the camera 10132 is hidden in the terminal body 1011 or exposed outside the terminal body 1011. For example, the control device includes a motor and a transmission component. The motor is connected to a control circuit of the terminal body 101, and the motor further is connected to the transmission component. The transmission component is connected to the movable member. The motor is configured for driving the movable member using the transmission component, such that the camera 10132 is hidden in the terminal body 1011 or exposed outside the terminal body 1011.

The transmission component is a gear set, and the gear set includes at least one gear.

In the present disclosure, the image device is arranged in the non-display region of the mobile terminal. The display region and the non-display region are arranged in the first surface 1011 and the second surface 1012 that are two adjacent surfaces of the terminal body 101 in a three-dimensional space. Thus, the display panel can be arranged in the first surface, and a preset region does not need to be reserved for a camera in the first surface, such that a frameless or narrow frame can be conveniently achieved.

As is understood by a person skilled in the art, the foregoing preferred embodiments of the present disclosure are illustrative rather than limiting of the present disclosure. It is intended that they cover various modifications and similar arrangements be included within the spirit and scope of the present disclosure, the scope of which should be accorded the broadest interpretation so as to encompass all such modifications and similar structures.

What is claimed is:

1. A mobile terminal, comprising:
a terminal body comprising a display region and a non-display region, wherein the display region is arranged on a first surface of the terminal body, the non-display region is arranged on a second surface of the terminal body, and the first surface and the second surface are two adjacent surfaces of the terminal body in a three-dimensional space; and
a display panel arranged on the display region of the terminal body;
an image device arranged on the non-display region of the terminal body, the image device comprising:
a movable member connected with the terminal body; and
a camera arranged on the movable member;
wherein the movable member is configured for driving the camera such that the camera is hidden in the terminal body or exposed outside the terminal body;
wherein the movable member comprises:
a bracket; and
a movable component connected with the bracket and the terminal body;
wherein the camera is arranged on the bracket;
wherein a preset included angle is defined between the first surface and the second surface;
wherein the preset included angle ranges from 20 degrees to 160 degrees.

2. The mobile terminal according to claim 1, wherein the bracket and the movable component are configured for hiding the camera in the terminal body or exposing the camera outside the terminal body in a translation or rotational manner.

3. The mobile terminal according to claim 2, wherein the movable component is a rotation shaft;
the bracket comprising a rotation hole;
wherein the rotation shaft is inserted into the rotation hole in a pivoting manner, and at least a part of the rotation shaft is fixed to the terminal body.

4. The mobile terminal according to claim 3, wherein the bracket is configured for rotating around the rotating shaft at a preset angle, such that the camera is hidden in the terminal body or exposed outside the terminal body.

5. The mobile terminal according to claim 3, wherein the bracket comprises a first end and a second end;
the rotating hole being arranged in the first end of the bracket; and
the camera being arranged at the second end of the bracket.

6. A mobile terminal, comprising:
a terminal body comprising a display region and a non-display region, wherein the display region is arranged on a first surface of the terminal body, the non-display region is arranged on a second surface of the terminal body, and the first surface and the second surface are two adjacent surfaces of the terminal body in a three-dimensional space; and
a display panel arranged on the display region of the terminal body;
an image device arranged on the non-display region of the terminal body, the image device comprising:
a movable member connected with the terminal body; and
a camera arranged on the movable member;
wherein the movable member is configured for driving the camera such that the camera is hidden in the terminal body or exposed outside the terminal body.

7. The mobile terminal according to claim 6, wherein the movable member further comprises:
a bracket; and
a movable component connected with the bracket and the terminal body;
wherein the camera is arranged on the bracket.

8. The mobile terminal according to claim 7, wherein the bracket and the movable component are configured for hiding the camera in the terminal body or exposing the camera outside the terminal body in a translation or rotational manner.

9. The mobile terminal according to claim 8, wherein the movable component is a rotation shaft;
the bracket comprising a rotation hole;
wherein the rotation shaft is inserted into the rotation hole in a pivoting manner, and at least a part of the rotation shaft is fixed to the terminal body.

10. The mobile terminal according to claim 9, wherein the bracket is configured for rotating around the rotating shaft at a preset angle, such that the camera is hidden in the terminal body or exposed outside the terminal body.

11. The mobile terminal according to claim 9, wherein the bracket comprises a first end and a second end;
the rotating hole being arranged in the first end of the bracket; and
the camera being arranged at the second end of the bracket.

12. The mobile terminal according to claim 8, wherein the movable component comprises an assembly of a sliding block and a sliding groove;
wherein one of the sliding block and the sliding groove is arranged in the terminal body, and the other of the sliding block and the sliding groove is arranged on an outer surface of the bracket.

13. The mobile terminal according to claim 12, wherein the bracket is configured for sliding along a track that is defined by the sliding block and the sliding groove, such that the camera is hidden in the terminal body or exposed outside the terminal body.

14. The mobile terminal according to claim 13, wherein the sliding groove comprises a wave shape, a spring is arranged in the sliding block, and the spring is connected with the terminal body or the bracket;
wherein the spring is configured to pop up or recover the sliding block, such that the sliding block is coupled with a wave peak and a wave trough in the sliding groove having the wave shape.

15. The mobile terminal according to claim 6, wherein the first surface and the second surface comprises a preset included angle;
wherein the preset included angle ranges from 20 degrees to 160 degrees.

16. The mobile terminal according to claim 15, wherein the preset included angle ranges from 70 degrees to 110 degrees.

17. The mobile terminal according to claim 15, wherein at least one of the first surface and the second surface is a planar or curved surface, and wherein when at least one of the first surface and the second surface is the curved surface, a plane corresponding to the first surface is defined as a tangent plane of the first surface in a central position of the first surface, and a plane corresponding to the second surface is defined as a tangent plane of the second surface in a central position of the second surface.

18. The mobile terminal according to claim 6, wherein the mobile terminal further comprises:
a control device arranged in the terminal body;
wherein the control device is configured to control movable member, such that the camera is hidden in the terminal body or exposed outside the terminal body.

19. The mobile terminal according to claim 18, wherein the control device comprises a motor and a transmission component, the motor is connected to a control circuit of the terminal body, the motor further is connected to the transmission component, the transmission component is connected to the movable member, wherein the motor is configured for driving the movable member using the transmission component, such that the camera is hidden in the terminal body or exposed outside the terminal body.

20. The mobile terminal according to claim 19, wherein the transmission component is a gear set, and the gear set comprises at least one gear.
